(19) United States
(12) Patent Application Publication
(10) Pub. No.: US 2026/0002601 A1
(43) Pub. Date: Jan. 1, 2026

(54) VALVE TIMING SOLENOID WITH SHEAR PIN CONNECTOR

(71) Applicant: RB Distribution. Inc., Colmar, PA (US)

(72) Inventors: Nicholas Baer, Colmar, PA (US); Joseph Gianndrea, Colmar, PA (US); Tim Pavlik, Philadelphia, PA (US)

(73) Assignee: RB Distribution. Inc., Colmar, PA (US)

(21) Appl. No.: 18/757,926

(22) Filed: Jun. 28, 2024

(51) Int. Cl. F16K 27/02

(52) U.S. Cl. CPC F16K 27/029

(57) ABSTRACT

A valve timing solenoid has a first part with an open end and a surrounding wall that has an aligned aperture and recess dimensioned to receive a shear pin. A second part has a projection that is inserted in the open end. The projection has a relief that is dimensioned to pass a shear pin connector that joins the parts as a unit. The valve timing solenoid may have a pair of shear pin connectors.

### BACKGROUND

A valve timing solenoid operates in conjunction with the engine control electronics to adjust for engine timing. The solenoid controls the position of the camshaft or the camshaft phasing by adjusting the oil flow through the hydraulic system associated with the camshaft.

The known valve timing solenoid is constructed as a two part unit having an upper body and a lower body that are retained together with a shear pin. The lower body part is typically a soft die-casted metal into which a shear pin is inserted to join the two parts. On many occasions, when it has become necessary to replace the valve timing solenoid, the mechanic attempting to replace the solenoid discovers that the seal or O-ring on the lower body part has become stuck in the engine recess. The force necessary to remove the solenoid often distorts the soft die-cast metal of the lower body part, which can lead to the shear pin slipping out of the lower body part or becoming bent from the force with the consequence that the lower body remains in the engine. This results int eh lower body portion being stuck in the engine recess.

### SUMMARY

The current solution provides a valve timing solenoid with a first part having an open end with an aperture in one part of the surrounding wall and an aligned recess in an opposite part of the surrounding wall. A second part has a projection that is received in the open end of the first part. The projection is undercut to form an annular ring that is positioned to aligned with the aperture and the recess. A shear pin is inserted in the joined parts so the shear pin has a first end in the aperture and the opposite second end in the recess.

### BRIEF DESCRIPTION OF THE DRAWINGS

FIG. 1 illustrates an exemplary valve timing solenoid;

FIG. 2 is an exploded view of a portion of the valve timing solenoid below the cap illustrated in FIG. 1;

FIG. 3 is an elevation view illustrating the solenoid portion in FIG. 2 assembled with the shear pins; and,

FIG. 4 is a longitudinal section along the lines 4-4 in FIG. 3.

### DETAILED DESCRIPTION

The valve timing solenoid will be described with reference to the above described figures wherein the numerals identify the same or a similar part.

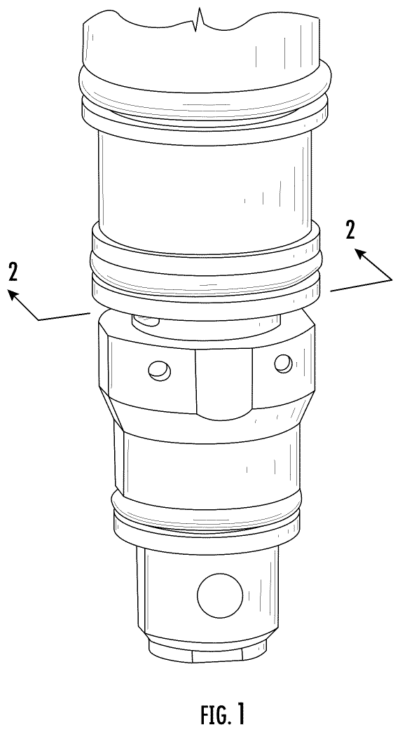

A valve timing solenoid 10 like that illustrated in FIG. 1 will typically have a cap or housing 12 that encloses some internal components and provides, an electrical connection point 14 for activation of the solenoid and a connection point 16 for securing the solenoid to the engine. The housing 12 typically contains a coil for generating a magnetic field that activates a plunger which controls the flow of a fluid for adjusting the valve timing accordance to performance demands. These component parts will vary according to the manufacturer and are not altered by the present disclosure, which is directed to the shear pin arrangement that secures or assembles the parts of the solenoid together.

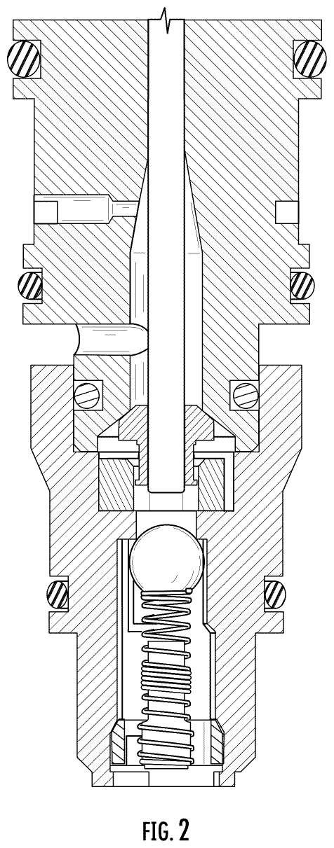

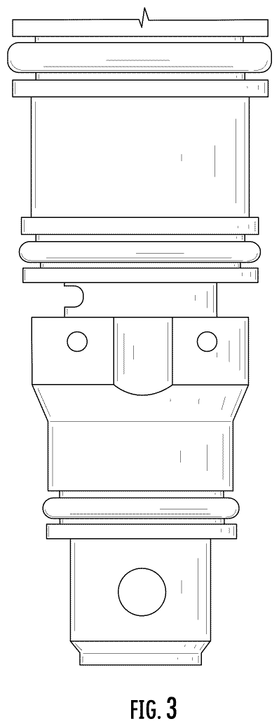

Still with reference to FIG. 1, the cap or housing 12 sits on an upper section 20 which contains the electrical elements and a plunger according to the manufacturer's specifications. The lower section 30 contains additional mechanical elements according to the manufacturer's specifications. The upper portion 20 and the lower portion 30 are joined together by one or more shear pins which are the focus hereof, as will be described in more detail with reference to FIGS. 2-4.

With reference to FIGS. 2-4, the upper section 20 and lower section 30 have a variety of sealing O-rings 22 which vary according to the manufacturer's specifications. The dependent portion or projection 23 has two rings 25 that define a relief, such as a groove or slot, 24 between the two rings 25. The rings 25 are dimensioned with a diameter that complements the diameter of the opening 32 defined by the wall 21 in the lower section 30. The groove or slot 24 is dimensioned that a pin 33 passes through a hole 32, the slot 24 and into a recess 34. In the configuration shown in FIGS. 1-4, a pair of pins 33 are sued to assemble the upper section 20 and lower section 30. This pairing of the pins 33 balances the stresses on the pins and provides a more balanced extraction force through the parts.

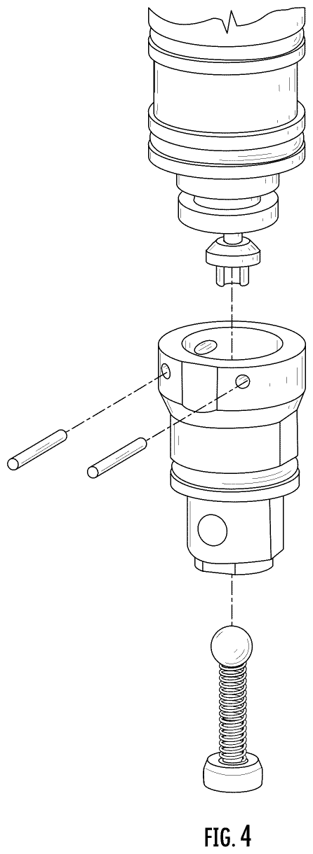

With reference to FIGS. 2 and 4, it can be seen that the projection 23 is received within the opening 31 and is seated on the shoulder 40. This aligns the plunger 43 and valve steam seats 28 in line with the ball check 38 that is biased toward the upper portion by the spring 37 that rides on the stem 36. Once again, this configuration is determined by the component's manufacturer. Still with reference to FIGS. 2 and 4, it can be seen that the pins 33 are inserted on either side of the projection 23 and pass through the apertures 32 and into the recesses 34 so both ends of the pins 33 are contained in the lower portion 30.

What is claimed is:

1. A valve timing solenoid comprising:
a first part with an open end defined by a surrounding wall that has at least one aperture and at least one recess that are aligned with each other and dimensioned to receive a shear pin;
a second part has a projection that fits within the open end and has a slot that is positioned to align with the at least one aperture and the at least one recess that permits passage of a shear pin between the at least one aperture and the at least one a recess; and,
a shear pin that passes through the at least one aperture and the at least one recess so that a first end of the shear pin is within the at least one aperture and a second end of the shear pin is within the at least one a recess.

2. The valve timing solenoid of claim 1, wherein the first part has a pair of apertures, a pair of recesses, and a pair shear pins, where each of the shear pins passes through one of the pair of apertures and into a respective one of the pair of recesses.

3. The valve timing solenoid of claim 1, wherein where in the shear pin joins the first part and the second part as a single unit.

4. The valve timing solenoid of claim 3, wherein the first part has two apertures and two recesses and are a pair of shear pins;
whereby each shear pin passes through a respective aperture and into a respective one of the two recesses and the valve timing solenoid is joined as a single unit.

5. A valve timing solenoid having:
has a first part with a wall that has an aperture and a recess that are aligned and dimensioned to receive a shear pin;
a second part has a projection that fits within an opening defined by the surrounding wall of the first part and has an annular slot that is dimensioned to permit passage of a shear pin; and,
a shear pin connector that passes through the aperture and into the recess.

6. A valve timing solenoid having:
a first part with an open end and a surrounding wall that has a pair of aligned apertures and recesses that are dimensioned to receive a shear pin.
a second part that has a projection dimensioned to fit within the open end of the first part, the projection has a slot located between a pair of rings; and
a shear pin is inserted in each of the pair of aligned apertures and into a respective aligned recess in the surrounding wall.
whereby the first part and the second pat are joined as a single unit by a shear pin located in each of the pair of aligned apertures and recesses.

7. A valve timing solenoid having:
has a first part with an aligned aperture and recess formed in a surrounding wall and dimensioned to receive a shear pin;
a second part has a projection that fits within an opening defined by the surrounding wall of the first part and has a relief that is dimensioned to permit passage of a shear pin past the second part; and,
a shear pin that extends between the aligned aperture and the recess.
